(19) United States
(12) Patent Application Publication
(10) Pub. No.: US 2010/0026158 A1
(43) Pub. Date: Feb. 4, 2010

(54) Heat dissipation structure of LED light

(76) Inventor: Ya Li Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,149

(22) Filed: Aug. 3, 2009

(30) Foreign Application Priority Data
Aug. 3, 2008 (TW) 097213855

(51) Int. Cl. H01J 61/52

(52) U.S. Cl. 313/46; 362/373

(57) ABSTRACT

A heat dissipation structure of LED light, including a ventilation lampshade, a ventilation power supply seat module and a streamlined curved-surface thermal module. The ventilation lampshade and the ventilation power supply seat module are formed with ventilation holes for expediting fluid convection and enhancing heat dissipation efficiency. The thermal module is composed of multiple radiating fins, which are adjacently annularly stacked to form the thermal module. The radiating fins are formed with streamlined curved surfaces, whereby fluid can more smoothly flow through the radiating fins to greatly enhance heat dissipation ability of the thermal module.

### BACKGROUND OF THE INVENTION

The present invention is related to an improved heat dissipation structure of LED light, and more particularly to an LED light with higher heat dissipation ability.

Currently, there is a trend of energy saving and carbon reduction all over the world. All kinds of high-brightness LED lights have been widely used in various fields to save power and energy. However, the LED chip modules of such high-brightness LED lights will generate high heat when working. The heat must be efficiently dissipated. Otherwise, the LED lights will malfunction. Therefore, it has become a critical issue how to dissipate the heat generated by the LED chip modules so as to keep the LED lighting systems functioning normally. In general, radiating fins are attached to the surfaces of the heat-generating components of the LED chip modules to conduct and dissipate the heat out of the LED lighting systems. Accordingly, the LED chip modules are protected from overheating so as to avoid luminous decay of the LED lighting systems and prolong lifetime thereof.

A conventional LED lighting system dissipates heat mainly by way of natural convection. The conventional LED lighting system has some defects in heat dissipation as follows:
(1) The power supply seat module of the conventional LED light is airtight sealed. In the power supply seat module of the conventional LED light, the printed circuit board (PCB) is simply enclosed in a housing. The housing has no ventilation hole so that the PCB is airtight sealed. In this case, the heat can be hardly dissipated outward. As a result, the high-temperature components on the PCB often burn out due to overheating. Therefore, the lifetime of the power supply seat of the conventional LED light is shortened.
(2) In the conventional LED light, the LED substrate module is simply enclosed in a lampshade. The lampshade has no ventilation hole so that the LED substrate module is airtight sealed. In this case, the heat can be hardly dissipated outward. As a result, the high-temperature components on the LED substrate module will overheat and the luminous decay of the LED light will accelerate.
(3) The heat sink for the conventional LED light has insufficient surface area. There are three types of heat sinks for the conventional LED lights. That is, die-casting type (FIG. 1), extruded aluminum type (FIG. 2) and stacked plane fin type (FIG. 3). With respect to the extruded aluminum type and the die-casting type, due to the limitation of mechanical processing performance, the radiating fins cannot be formed with very thin thickness. Therefore, the number of the radiating fins of the heat sink is quite limited. Accordingly, the density (total heat dissipation area per unit volume) is lower. With respect to the stacked plane fin type, the radiating fins can be made with very thin thickness to have higher density, that is, greater total heat dissipation area per unit volume. Therefore, such type of heat sink has higher heat dissipation ability. However, currently, the radiating fins of such type of heat sink are generally arranged in an upright state. The heat sink with the upright radiating fins still fails to provide sufficient heat dissipation surface area.

### SUMMARY OF THE INVENTION

It is therefore a primary object of the present invention to provide an LED light with high heat dissipation efficiency. The LED light includes an LED substrate module, a ventilation power supply seat module, a ventilation lampshade and an annular thermal module. The annular thermal module is composed of multiple streamlined curved-surface radiating fins stacked in an annular pattern.

The radiating fins are formed with streamlined curved surfaces to increase heat dissipation surface area of each radiating fin. In addition, fluid can more smoothly flow through the radiating fins to enhance heat dissipation efficiency. The ventilation power supply seat module and the ventilation lampshade are formed with ventilation holes for expediting fluid convection and enhancing heat dissipation efficiency of the LED light.

To achieve the above and other objects, the heat dissipation structure of LED light of the present invention includes a lampshade with ventilation holes, a power supply seat module with ventilation holes, a streamlined curved-surface thermal module and an LED substrate module.

In the conventional LED light, the LED substrate module lad is simply enclosed in a lampshade. The lampshade has no ventilation hole so that the LED substrate module is airtight sealed. In this case, the heat can be hardly dissipated outward. As a result, the high-temperature components on the LED substrate module often overheat to accelerate luminous decay of the LED light.

In contrast, the lampshade with ventilation holes of the present invention is composed of an inner casing and an outer casing. The LED substrate module is positioned in the inner casing. Glue is dispensed on the entire bottom edge of the inner casing to adhere the inner casing onto the LED substrate module or the top face of the thermal module. Under such circumstance, the LED substrate module is dustproof and watertight enclosed in the inner casing. The outer casing of the lampshade is formed with ventilation holes for expediting fluid convection between the inner casing and the outer casing so as to enhance heat dissipation efficiency.

In the power supply seat module of the conventional LED light, the printed circuit board (PCB) is simply enclosed in a housing 1ac. The housing has no ventilation hole so that the PCB is airtight sealed. In this case, the heat can be hardly dissipated outward. As a result, the high-temperature components on the PCB often burn out due to overheating.

In contrast, the power supply seat module with ventilation holes of the present invention is composed of a rectangular inner casing and an outer casing. The PCB is positioned in the rectangular inner casing and a thermally conductive adhesive is filled into the inner casing to achieve dustproof and watertight as well as heat conduction effect. Also, the temperature of the high-temperature components on the PCB can be decreased. The outer casing is formed with ventilation holes for expediting fluid convection and enhancing heat dissipation efficiency.

The streamlined curved-surface thermal module includes multiple streamlined curved-surface radiating fins connected with each other. Each of the radiating fins has a main body and a sectorial skirt connected with a lateral side of the main body. Two ends of the sectorial skirt are two concentric arcs with different sizes and different radiuses. A middle section of the main body is punched with a notch. When the radiating fins are assembled and stacked into a closed annular pattern, the sectorial skirts of the radiating fins tightly abut against each other to avoid overlapping of the radiating fins and keep a precise size. Also, when the radiating fins are stacked into the closed annular pattern, the notches of the radiating fins together form a closed annular groove. A ring-shaped retainer member with the same size as the annular groove is positioned in the annular groove to locate the radiating fins and prevent the radiating fins from deflecting toward the center of the heat sink. The radiating fins are latched with each other and stacked in the annular pattern to form the streamlined curved-surface thermal module.

Each of the radiating fins is formed with streamlined curved surfaces. Larger amount of fluid can more smoothly flow through the streamlined curved surfaces to enhance heat dissipation efficiency. The radiating fin can be designed with any of various optimized streamlined curved surfaces in accordance with the flow field. For example, the radiating fin can be formed with irregular multi-curved surfaces, double-curved surfaces, S-twisted curved surfaces, mono-curved surfaces, arced surfaces, etc.

The radiating fin is formed with skirts. By means of latching the skirts with each other, multiple radiating fins can be stacked and stringed into an annular pattern. Accordingly, the radiating fins can be easily assembled into an integral body.

The sectorial skirt of the bottom of the radiating fin is further upward bent into a U-shaped section. When the radiating fins are stacked into the annular pattern, the predetermined sectorial skirts of the bottoms of the radiating fins can tightly abut against each other to avoid overlapping of the radiating fins and keep a precise size.

The conventional sectorial skirt has R angle. In case of poor assembly, two radiating fins may partially overlap each other. Therefore, the sectorial skirt is further upward bent into the U-shaped section to eliminate the possibility of overlapping of the radiating fins.

The ring-shaped retainer member has two major functions as follows:
1. The retainer member serves to locate the radiating fins. The radiating fins is formed with a notch on inner side, when the radiating fins are latched and stacked into the annular pattern, the notches of the radiating fins together forming an annular groove, whereby a ring-shaped retainer member is positioned in the notches to locate the radiating fins and prevent the radiating fins from deflecting toward the center of the heat sink.
2. The retainer member serves to fix the power supply seat in two manners. The ring-shaped retainer member is disposed with threaded holes. The plastic power supply seat is formed with through holes corresponding to the threaded holes. Screws can be passed through the through holes and screwed into the threaded holes to lock the power supply seat on the ring-shaped retainer member.

The LED substrate is made of metal plate with high thermal conductivity.

The present invention can be best understood through the following description and accompanying drawings wherein:

### BRIEF DESCRIPTION OF THE DRAWINGS

FIG. 1 is a perspective view of a conventional LED light with die-casting type heat dissipation structure;

FIG. 2 is a perspective view of a conventional LED light with extruded aluminum type heat dissipation structure;

FIG. 3 is a perspective view of a conventional LED light with stacked plane fin type heat dissipation structure;

FIG. 4 is a perspective assembled view of the LED light with the streamlined curved-surface heat dissipation structure of the present invention;

FIG. 5 is a perspective exploded view of the LED light with the streamlined curved-surface heat dissipation structure of the present invention;

FIG. 6 is a perspective assembled view of the streamlined curved-surface thermal module of the present invention;

FIG. 7 is a perspective view of the streamlined curved-surface radiating fin of the present invention;

FIG. 8 is a perspective view of the LED substrate module of the present invention;

FIG. 9 is a perspective view of the ring-shaped retainer member of the present invention;

FIG. 10 is a perspective view of the ventilation lampshade of the present invention; and

FIG. 11 is a perspective view of the ventilation power supply seat module of the present invention.

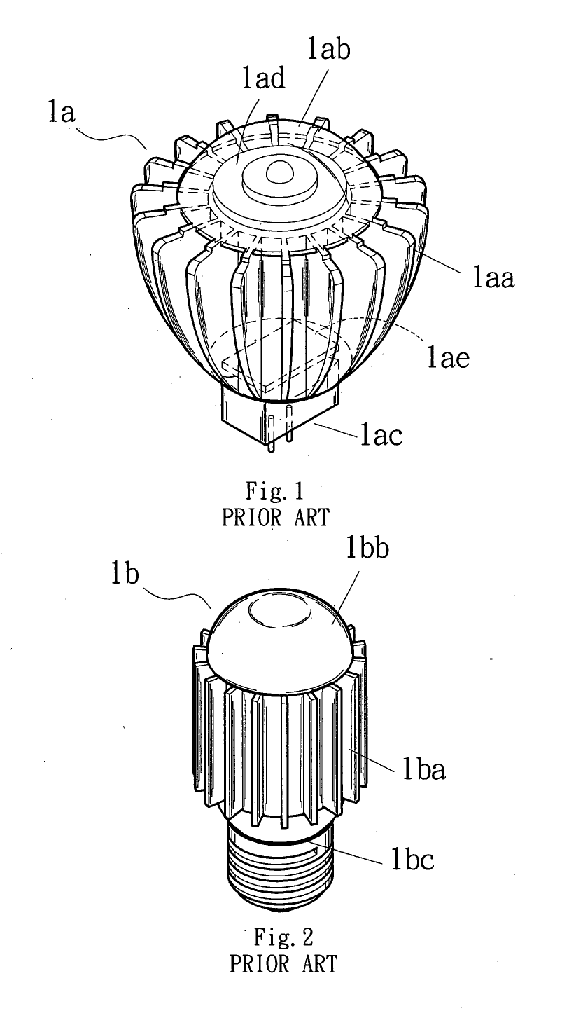

### DETAILED DESCRIPTION OF THE PREFERRED EMBODIMENTS

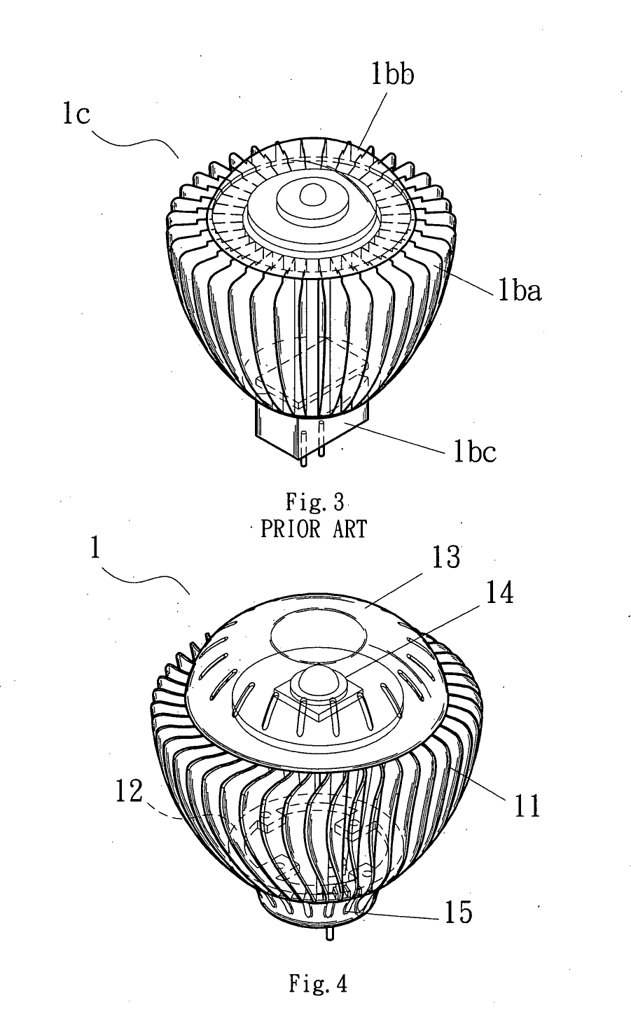

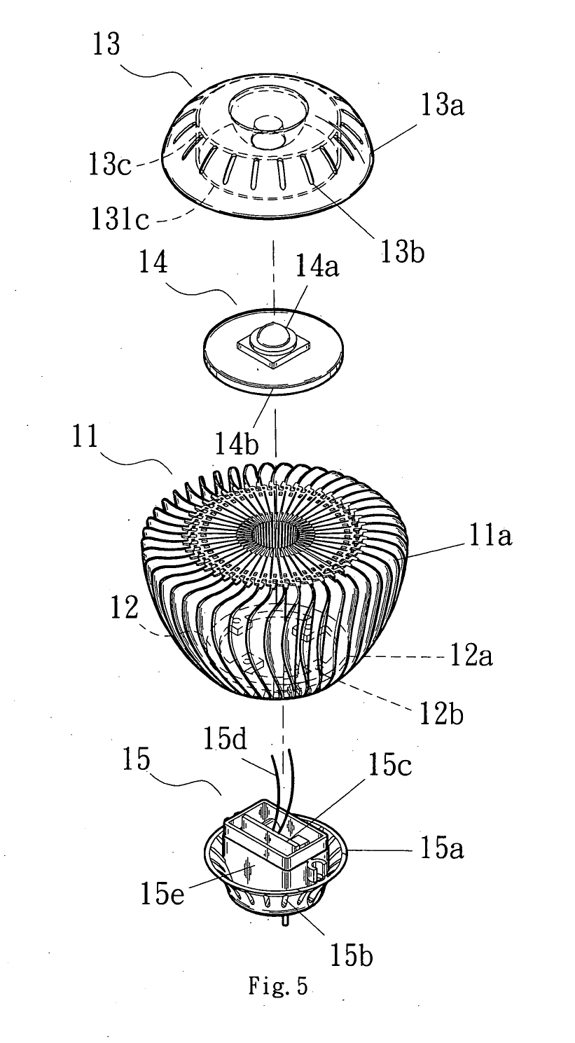

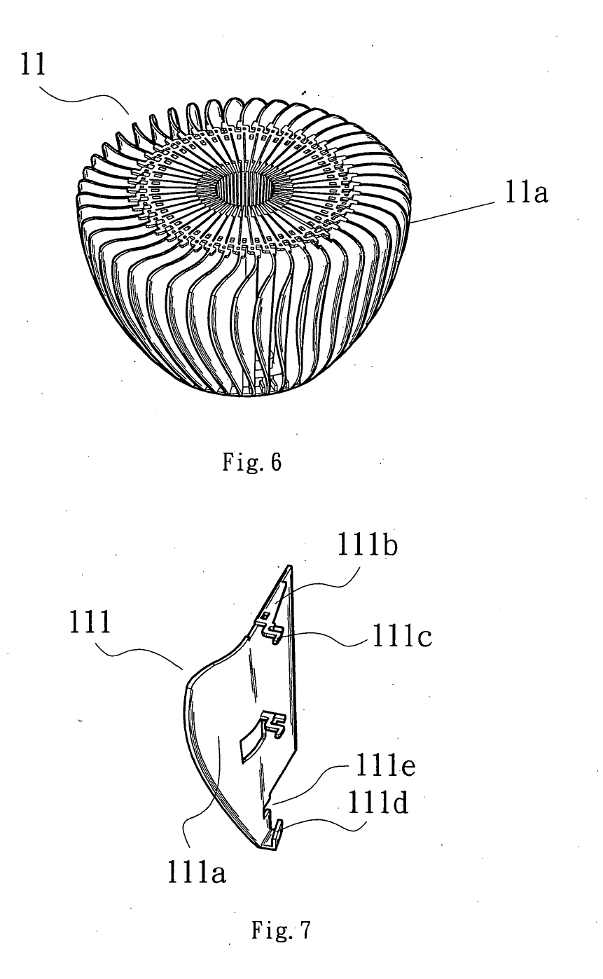

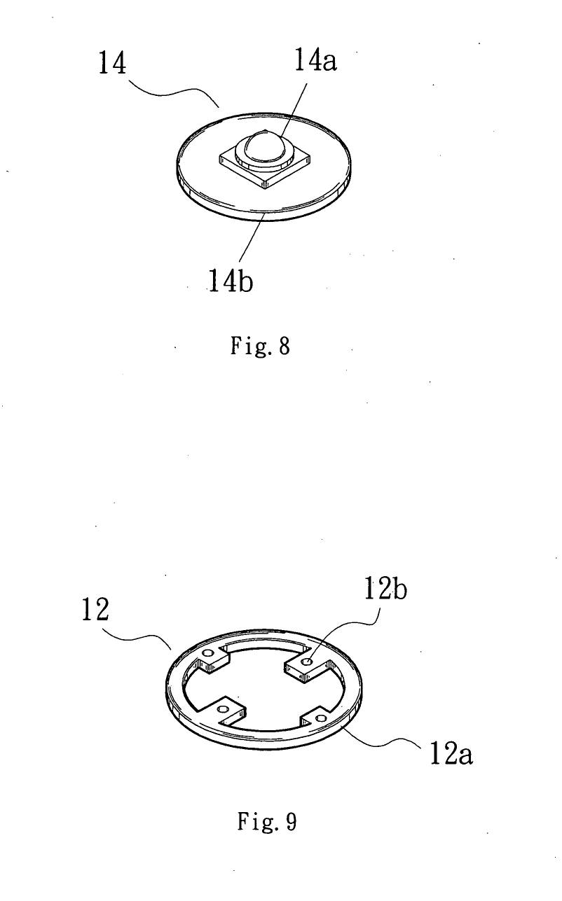

Please refer to FIGS. 4 to 11. The heat dissipation structure 1 of LED light of the present invention includes a lampshade 13 with ventilation holes 13b (as shown in FIGS. 4, 5 and 10), a power supply seat module 15 with ventilation holes 13b (as shown in FIGS. 5 and 11), a streamlined curved-surface thermal module 11 (as shown in FIG. 6) and an LED substrate module 14.

In the conventional LED light 1a, the LED substrate module 1ad is simply enclosed in a lampshade 1ab. The lampshade has no ventilation hole so that the LED substrate module 1ad is airtight sealed. In this case, the heat can be hardly dissipated outward. As a result, the high-temperature components on the LED substrate module 1ad often overheat to accelerate luminous decay of the LED light.

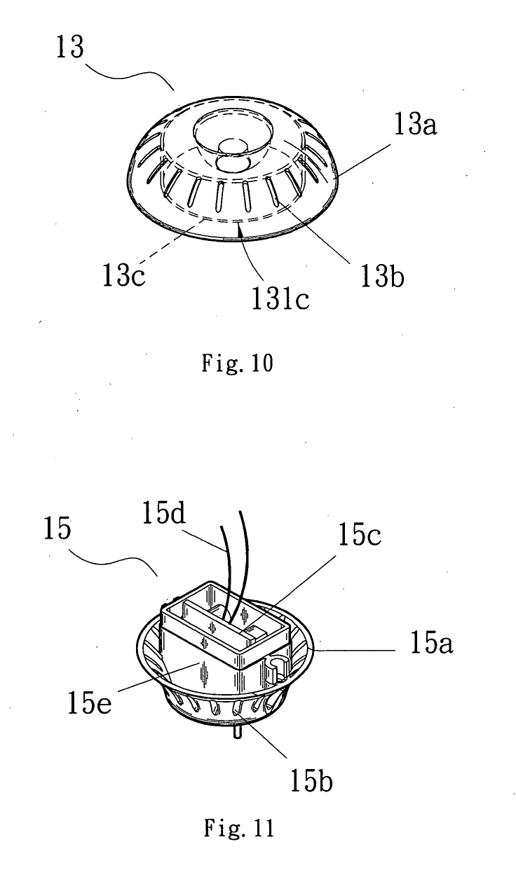

In contrast, the lampshade 13 with ventilation holes 13b (as shown in FIGS. 4, 5 and 10) of the present invention is composed of an inner casing 13c and an outer casing 13a. The LED substrate module 14 is placed into the inner casing 13c of the lampshade 13 (as shown in FIG. 10). Glue is dispensed on the entire bottom edge 131c of the inner casing 13c (as shown in FIGS. 5 and 10) to adhere the inner casing 13c onto the LED substrate module 14 or the top of the thermal module 11. Thereafter, the bottom edge of the outer casing 13a of the lampshade 13 is also adhered to the top of the thermal module 11 (as shown in FIGS. 5 and 6) to define a closed space. Under such circumstance, the LED substrate module 14 is dustproof and watertight enclosed in the inner casing 13c of the lampshade 13. The outer casing 13a of the lampshade 13 is formed with ventilation holes 13b for expediting fluid convection and enhancing heat dissipation efficiency.

In the power supply seat module of the conventional LED light, the printed circuit board (PCB) 1ae is simply enclosed in a housing 1ac. The housing has no ventilation hole so that the PCB 1ae is airtight sealed. In this case, the heat can be hardly dissipated outward. As a result, the high-temperature components on the PCB often burn out due to overheating.

In contrast, the ventilation power supply seat module 15 (as shown in FIGS. 5 and 11) of the present invention is composed of a rectangular inner casing 15e and an outer casing 15a. As shown in FIG. 11, the PCB 15c is placed into the rectangular inner casing 15e and a thermally conductive adhesive is filled into the inner casing to achieve dustproof and watertight as well as heat conduction effect. Also, the temperature of the high-temperature components on the PCB 15c can be decreased. The outer casing 15a is formed with ventilation holes 15b (as shown in FIG. 11) for expediting fluid convection and enhancing heat dissipation efficiency.

The streamlined curved-surface thermal module 11 (as shown in FIG. 6) includes multiple radiating fins 111 each of which is formed with streamlined curved surfaces 111a (as shown in FIG. 7). Larger amount of fluid can more smoothly flow through the streamlined curved surfaces 111a to enhance heat dissipation efficiency. The radiating fin 111 can be designed with any of various optimized streamlined curved surfaces 111a in accordance with the flow field. For example, the radiating fin 111 can be formed with irregular multi-curved surfaces, double-curved surfaces, S-twisted curved surfaces, mono-curved surfaces, arced surfaces, etc.

Referring to FIG. 7, the radiating fin is formed with sectorial skirts 111b (as shown in FIG. 7). By means of latching the sectorial skirts 111b with each other, multiple radiating fins 111 can be stacked and stringed into an annular pattern. Accordingly, the radiating fins 111 can be easily assembled into an integral body.

The sectorial skirt 111b of the bottom of the radiating fin 111 is further upward bent into a U-shaped section 111d (as shown in FIG. 7). When the radiating fins 111 are stacked into the annular pattern, the sectorial skirts 111b and the U-shaped section 111d of the radiating fins 111 can tightly abut against each other to avoid overlapping of the radiating fins 111 and keep a precise size.

The conventional sectorial skirt 111b has R angle. In case of poor assembly, two radiating fins 111 may partially overlap each other. Therefore, the sectorial skirt 111b is further upward bent into the U-shaped section 111d to eliminate the possibility of overlapping of the radiating fins 111.

The present invention further includes a ring-shaped retainer member 12 (as shown in FIG. 9). The retainer member 12 has two major functions as follows:
1. The retainer member 12 serves to locate the radiating fins 111. A skirt on inner side of the radiating fin 111 is formed with a notch 111e (as shown in FIG. 7). When the radiating fins 111 are latched and stacked into the annular pattern, the notches 111e of the radiating fins 111 together form an annular groove. The ring-shaped retainer member 12 is positioned in the annular groove to locate the radiating fins 111 and prevent the radiating fins 111 from deflecting toward the center of the heat sink.
2. The retainer member 12 serves to fix the power supply seat in two manners. The ring-shaped retainer member 12 is disposed with threaded holes 12b (as shown in FIG. 9). The power'supply seat is formed with through holes corresponding to the threaded holes 12b. Screws can be passed through the through holes and screwed into the threaded holes to lock the power supply seat on the ring-shaped retainer member 12.

In the LED substrate module 14, the LED substrate 14b is made of metal plate with high thermal conductivity and connected to the LED unit 14a.

The above embodiments are only used to illustrate the present invention, not intended to limit the scope thereof. Many modifications of the above embodiments can be made without departing from the spirit of the present invention.

What is claimed is:

1. A heat dissipation structure of LED light comprising:
at least one LED unit 14a;
a thermally conductive substrate 14b on which the LED unit 14a is connected;
a thermal module 11 connected to the thermally conductive substrate 14b for dissipating heat generated by the LED unit 14a to the atmosphere;
a circuit board 15c including at least one circuit electrically connected to the LED unit 14a;
a power supply seat 15, which is a hollow housing, the circuit board 15c being disposed in the hollow housing; and
a lampshade 13 covering the LED unit 14a, the lampshade being formed with ventilation holes 15b for expediting fluid convection and enhancing heat dissipation efficiency.

2. The heat dissipation structure of LED light as claimed in claim 1, wherein the thermal module 11 is an annular structure composed of multiple radiating fins 111, the radiating fins 111 being adjacently annularly stacked to form the thermal module 11.

3. The heat dissipation structure of LED light as claimed in claim 2, wherein each of the radiating fins 111 is formed with streamlined curved surfaces 111a, whereby fluid can more smoothly flow through the radiating fin 111 to enhance heat dissipation efficiency.

4. The heat dissipation structure of LED light as claimed in claim 3, wherein the radiating fin 111 is designed with at least one of the optimized streamlined curved surfaces 111a in accordance with flow field, such as irregular multi-curved surfaces, double-curved surfaces, S-twisted curved surfaces, mono-curved surfaces, arced surfaces, etc.

5. The heat dissipation structure of LED light as claimed in claim 2, wherein each of the radiating fins 111 is formed with a sectorial skirt 111b, whereby by means of latching the sectorial skirts 111b of the radiating fins 111 with each other, the radiating fins 111 can be stacked and stringed into an annular pattern, when the radiating fins 111 are stacked into the annular pattern, the sectorial skirts 111b of the bottoms of the radiating fins 111 tightly abutting against each other to keep a precise size.

6. The heat dissipation structure of LED light as claimed in claim 5, wherein the sectorial skirt 111b of the bottom of the radiating fin 111 is further upward bent into a U-shaped section 111d, whereby when the radiating fins 111 are stacked into the annular pattern, the sectorial skirts 111b of the bottoms of the radiating fins 111 at intervals tightly abut against each other to avoid overlapping of the radiating fins 111.

7. The heat dissipation structure of LED light as claimed in claim 2, wherein upper sides and lower sides of each of the radiating fins 111 are latched with each other to assemble the radiating fins 111.

8. The heat dissipation structure of LED light as claimed in claim 2, wherein lateral sides of each of the radiating fins 111 are latched with each other to assemble the radiating fins 111.

9. The heat dissipation structure of LED light as claimed in claim 2, wherein each of the radiating fins 111 is formed with a notch 111e on inner side, when the radiating fins 111 are latched and stacked into the annular pattern, the notches 111e of the radiating fins 111 together forming an annular groove, whereby a ring-shaped retainer member 12 is positioned in each of the notches 111e to locate the radiating fins 111 and prevent the radiating fins from deflecting toward the center of the thermal module 11.

10. The heat dissipation structure of LED light as claimed in claim 3, wherein each of the radiating fins 111 is formed with a notch 111e on inner side, when the radiating fins 111 are latched and stacked into the annular pattern, the notches 111e of the radiating fins 111 together forming an annular groove, whereby a ring-shaped retainer member 12 is positioned in each of the notches 111e to locate the radiating fins 111 and prevent the radiating fins from deflecting toward the center of the thermal module 11.

11. The heat dissipation structure of LED light as claimed in claim 4, wherein each of the radiating fins 111 is formed with a notch 111e on inner side, when the radiating fins 111 are latched and stacked into the annular pattern, the notches 111e of the radiating fins 111 together forming an annular groove, whereby a ring-shaped retainer member 12 is positioned in each of the notches 111e to locate the radiating fins 111 and prevent the radiating fins from deflecting toward the center of the thermal module 11.

12. The heat dissipation structure of LED light as claimed in claim 9, wherein the ring-shaped retainer member 12 is disposed with threaded holes 12b and the plastic power supply seat 15 is formed with through holes corresponding to the threaded holes, whereby screws are passed through the through holes and screwed into the threaded holes to lock the power supply seat 15 on the ring-shaped retainer member 12.

13. The heat dissipation structure of LED light as claimed in claim 1, wherein the lampshade 13 includes an inner casing 13c and an outer casing 13a, the LED substrate module 14 being dustproof and watertight enclosed in the inner casing 13c, the outer casing 13a of the lampshade 13 being formed with ventilation holes 13b for expediting fluid convection and enhancing heat dissipation efficiency.

14. The heat dissipation structure of LED light as claimed in claim 2, wherein the lampshade 13 includes an inner casing 13c and an outer casing 13a, the LED substrate module 14 being dustproof and watertight enclosed in the inner casing 13c, the outer casing 13a of the lampshade 13 being formed with ventilation holes 13b for expediting fluid convection and enhancing heat dissipation efficiency.

15. The heat dissipation structure of LED light as claimed in claim 3, wherein the lampshade 13 includes an inner-casing 13c and an outer casing 13a, the LED substrate module 14 being dustproof and watertight enclosed in the inner casing 13c, the outer casing 13a of the lampshade 13 being formed with ventilation holes 13b for expediting fluid convection and enhancing heat dissipation efficiency.

16. The heat dissipation structure of LED light as claimed in claim 1, wherein the power supply seat 15 is formed with ventilation holes 15b for expediting fluid convection and enhancing heat dissipation efficiency.

17. The heat dissipation structure of LED light as claimed in claim 2, wherein the power supply seat 15 is formed with ventilation holes 15b for expediting fluid convection and enhancing heat dissipation efficiency.

18. The heat dissipation structure of LED light as claimed in claim 3, wherein the power supply seat 15 is formed with ventilation holes 15b for expediting fluid convection and enhancing heat dissipation efficiency.

19. The heat dissipation structure of LED light as claimed in claim 1, wherein the power supply seat 15 includes an inner casing 15e and an outer casing 15a, the inner casing 15e and a thermally conductive adhesive being filled into the inner casing 15e to achieve dustproof and watertight as well as heat conduction effect, the outer casing 15a being formed with ventilation holes 15b for expediting fluid convection and enhancing heat dissipation efficiency.

20. The heat dissipation structure of LED light as claimed in claim 2, wherein the power supply seat 15 includes an inner casing 15e and an outer casing 15a, the inner casing 15e and a thermally conductive adhesive being filled into the inner casing 15e to achieve dustproof and watertight as well as heat conduction effect, the outer casing 15a being formed with ventilation holes 15b for expediting fluid convection and enhancing heat dissipation efficiency.
